(19) United States
(12) Patent Application Publication
(10) Pub. No.: US 2012/0206848 A1
(43) Pub. Date: Aug. 16, 2012

(54) PLUGGABLE SURGE PROTECTION SYSTEM

(75) Inventors: Brian John GILLESPIE, Hummelstown, PA (US); Christopher Jon LAUBACH, Marietta, PA (US); Russell David MOSER, Lewisberry, PA (US); David Michael McCLELLAN, Camp Hill, PA (US); Scott Keith MICKIEVICZ, Elizabethtown, PA (US)

(73) Assignee: PHOENIX CONTACT DEVELOPMENT & MANUFACTURING, INC., Middletown, PA (US)

(21) Appl. No.: 13/329,793

(22) Filed: Dec. 19, 2011

Related U.S. Application Data
(60) Provisional application No. 61/441,438, filed on Feb. 10, 2011.

(51) Int. Cl. H02H 5/04; H01R 43/00; H02H 3/20

(52) U.S. Cl. 361/104; 361/118; 29/825

(57) ABSTRACT

A surge protection system including a pluggable surge protection cartridge and its corresponding base is disclosed. The cartridge includes a housing, a surge protection assembly situated within the housing containing a surge protection element and a plurality of cartridge contacts in electrical contact with the surge protection assembly. The cartridge contacts are configured to engage a base within an electrical load center to carry a surge current from the load center across an electrical path of the surge protection assembly through the surge protection element. The cartridge is configured to be situated within the base such that the cartridge is removable from the base while the base remains in electrical contact with the load center.

### CROSS-REFERENCE TO RELATED APPLICATIONS

This application claims priority to U.S. Provisional Application No. 61/441,438, filed Feb. 10, 2011, which is hereby incorporated by reference in its entirety.

### FIELD

The present invention is directed to surge protection and more particularly to surge protective devices used in conjunction with an electrical load center.

### BACKGROUND

Power distribution boxes, also commonly referred to as load centers, are used to provide electrical power to homes and other buildings from incoming electrical power lines. Power lines generally pass from an electric pole through a meter and are then received at the load center. At the load center, power flows through circuit breakers that direct power to individual circuits inside the home. An overcurrent situation is an event in which a particular circuit draws more current than a predetermined limit; in that case, the circuit breaker trips and disconnects the circuit from the power source.

In addition to overcurrent situations, voltage spikes and surges create overvoltage situations that are capable of damaging electrical equipment connected to the load center. Surge protectors are commonly used to protect against these situations. The surge protector responds to the overvoltage, discharging it to ground or neutral. Surge protectors are often used within a given circuit at a particular outlet to protect sensitive equipment such as televisions, computers and other electronics that are plugged into that outlet.

Surge protectors are also sometimes connected directly to the load center. While this arrangement can provide a greater level of protection in some circumstances, currently available surge protectors connected directly to the load center are unsatisfactory for a variety of reasons.

If the overvoltage surge energy exceeds the capacity of a surge protective device, it will be damaged and may need to be replaced. A particularly problematic drawback with current surge protectors connected to the load center is that these devices are consumer unfriendly and not only require a professional electrician for installation, but also to service and replace a spent surge protector.

These and other drawbacks are found in surge protectors that are currently available.

### SUMMARY

What is needed is a load center surge protection system that is more consumer friendly, so that after professional installation, subsequent replacement can be accomplished directly by the consumer.

According to an exemplary embodiment of the invention, a surge protection system is provided. The surge protection system includes a base that can be connected within a load center in much the same way as a circuit breaker. The system further includes a replaceable cartridge which houses the working components of the surge protector. The cartridge plugs into a receptacle formed in the base such that when the two are connected, unwanted power can flow through the surge protection system and be dissipated through one or more circuits.

In one embodiment, a surge protection system comprises a base configured to attach to a busbar of an electrical load center and be in electrical contact therewith, the base having a receptacle formed therein. The system also includes a cartridge containing a surge protection assembly having a surge protection element. The cartridge is configured to be received in the base receptacle such that the cartridge is in mechanical and electrical contact with the base. The cartridge is in electrical contact with the load center via the base such that a surge current passing through the load center flows through the surge protection element contained within the cartridge. The cartridge is removable from the base while the base remains in electrical contact with the load center.

In one embodiment, a pluggable surge protection cartridge comprises a housing; a surge protection assembly situated within the housing containing a surge protection element; and a plurality of cartridge contacts in electrical contact with the surge protection assembly. The cartridge contacts are configured to engage a base within an electrical load center and carry a surge current from the load center across an electrical path of the surge protection assembly through the surge protection element. The cartridge is configured to be situated within the base such that the cartridge is removable from the base while the base remains in electrical contact with the load center.

In another embodiment, a pluggable surge protection cartridge comprises a housing, a surge protection assembly situated within the housing, a plurality of cartridge contacts in electrical communication with the surge protection assembly, and a dielectric filler within the housing. In an embodiment, the surge protection assembly comprises a printed circuit board, a plurality of metal oxide varistors, a plurality of thermal fuses, and a plurality of wire filament fuses. In one embodiment, the varistors, thermal fuses and wire filament fuses are in electrical contact with the printed circuit board to form an electrical path in which current travels in multiple parallel paths across each of a thermal fuse, varistor and wire filament fuse in series. In some embodiments, the thermal fuses are supported by a thermal fuse carrier mounted on the printed circuit board such that the thermal fuses are retained in a predetermined position with respect to the printed circuit board. In some embodiments, the wire filament fuses each comprise a wire filament configured to consist of two straight leg portions connected by a smooth arc portion.

In certain embodiments, the cartridge contacts have a j-hook at one end to engage a corresponding base within an electrical load center and carry a surge current from the load center across the electrical path of the surge protection assembly. In some embodiments, the cartridge contacts further comprise a lance situate within the housing, the lance configured to resist movement of the cartridge contacts with respect to the housing.

In the event of an overvoltage situation where the voltage exceeds a pre-determined value associated with the surge protection system, a surge protection assembly within the cartridge according to exemplary embodiments of the invention is activated, preventing the overvoltage from reaching the electrical devices attached to the circuit(s) with which the surge protector is associated. A surge protector that has diverted more energy than it was designed for may be damaged and require replacement.

Unlike currently available surge protection devices installed at or near the load center, surge protection capability in accordance with exemplary embodiments can be restored by removing the spent cartridge from the base and replacing it with a new cartridge and can further be accomplished directly by the consumer without the need for an electrician.

Other features and advantages will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a surge protection system in accordance with an exemplary embodiment.

FIGS. 2 and 3 illustrate the surge protection system of FIG. 1 in accordance with an exemplary embodiment installed in a load center prior to and after cartridge insertion.

FIG. 4 illustrates the surge protection system of FIG. 1 prior to cartridge insertion with a partial cross-sectional view of the base.

FIG. 5 illustrates the surge protection system of FIG. 1, with the base housing portion of the base removed.

FIG. 6 illustrates a bottom view of the cartridge of FIG. 1.

FIG. 7 illustrates an exploded view of a cartridge in accordance with an exemplary embodiment.

FIG. 8 illustrates a surge protection assembly in accordance with an exemplary embodiment.

FIGS. 9a and 9b schematically and diagrammatically illustrate the electrical path of a surge protection assembly in accordance with an exemplary embodiment.

FIG. 10 illustrates a surge protection assembly in accordance with an exemplary embodiment with the MOVs removed.

FIG. 11 illustrates a wire fuse for use in a surge protection assembly in accordance with an exemplary embodiment.

FIG. 12 illustrates a thermal fuse carrier for use in a surge protection assembly in accordance with an exemplary embodiment.

FIG. 13 illustrates two nested surge protection assemblies for use in accordance with an exemplary embodiment having a two phase surge protection system.

FIG. 14 illustrates a cross-sectional view of a cartridge showing an alternative arrangement of a surge protection assembly in accordance with an exemplary embodiment.

FIG. 15 illustrates an arrangement of surge protection assemblies for use in accordance with an exemplary embodiment having a three phase surge protection system.

FIGS. 16a and 16b illustrate a cartridge and base for use with a three phase surge protection system.

FIG. 17 illustrates a surge protection system in accordance with another exemplary embodiment.

FIG. 18 illustrates a surge protection system in accordance with yet another exemplary embodiment.

FIGS. 19 and 20 illustrate extraction features formed in the cartridge in accordance with exemplary embodiments.

FIG. 21 illustrates a cartridge having a flip-up handle for use as an extraction feature in accordance with another exemplary embodiment.

FIGS. 22a and 22b illustrate a cartridge having a flip-up handle for use as an extraction feature in accordance with yet another exemplary embodiment.

FIG. 23 illustrates a gang of two single phase surge protection systems in accordance with an exemplary embodiment.

### DETAILED DESCRIPTION OF EXEMPLARY EMBODIMENTS

Exemplary embodiments are directed to a pluggable surge protection system that can be connected to or within a load center, but which enables an individual without professional training, such as a consumer, to readily replace spent cartridges without the need to hire an electrician.

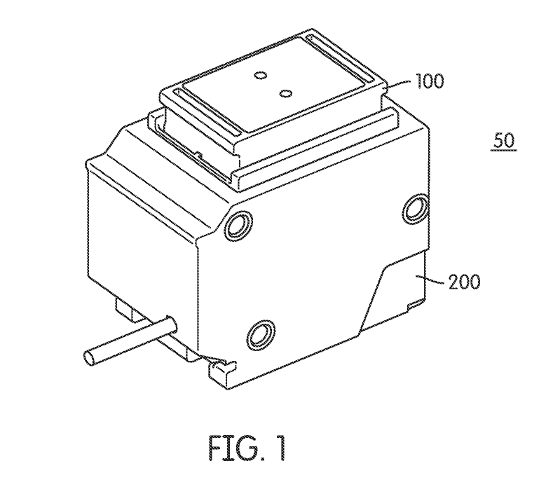

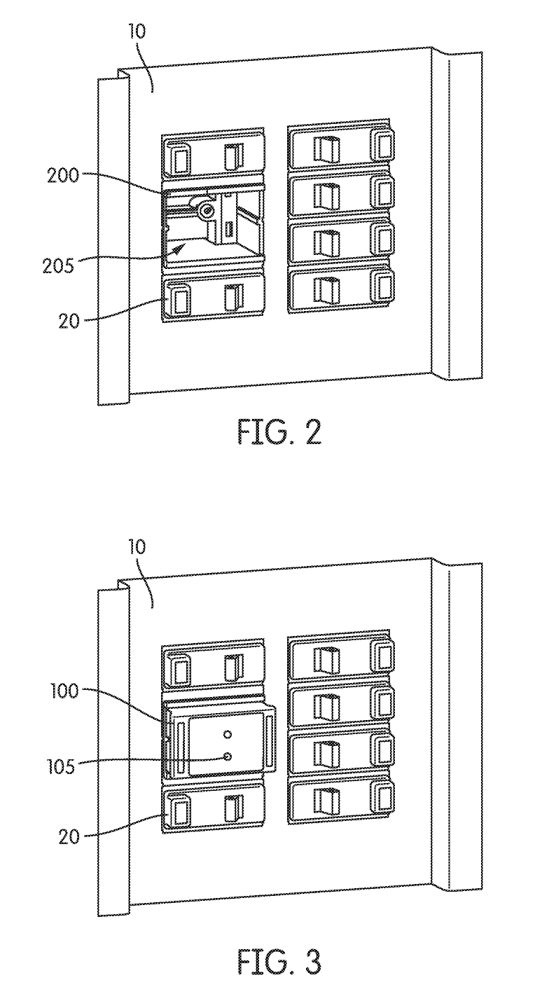

Turning to FIG. 1, a base 200 and a cartridge 100 configured to be received within the base 200 form a pluggable surge protection system 50. The base 200 is adapted for installation within an electrical load center 10, as seen in FIGS. 2 and 3. There, a two phase base 200 is shown installed in the load center 10, which can occur in much the same way as a circuit breaker 20 with the base 200 in mechanical and electrical contact with a busbar (not shown) within the load center 10.

The base 200 is sized and shaped to fit within one or more extra openings (depending on whether the pluggable surge protection system 50 is one phase, two phase, or three phase) within the load center 10. When the dead panel of the load center 10 is removed, the base 200 can be installed within the same footprint as a circuit breaker 20 and thus can be added to expansion slots alongside the circuit breakers 20 in a standard load center 10. From a consumer standpoint, the base 200 is essentially permanent upon installation by an electrician, residing behind the dead panel and hard wired to the load center 10. However, a receptacle 205 (FIG. 2) formed in the base 200 is exposed through the dead panel and the cartridge 100 can be replaced readily (FIG. 3) without the need to remove the dead panel or to reveal the wiring behind it. As a result, the consumer can replace a cartridge and insert a new one without further service by an electrician. Put another way, the cartridge 100 can be safely removed while the base 200 remains in electrical contact with the load center 10.

It will be appreciated that exemplary embodiments are shown and discussed herein with respect to American-style load centers constructed according to NEMA standards, although the principles of the invention are also applicable to other style load centers according to other types of standards and/or other equipment practices, including those employing a DIN rail.

As also shown in FIG. 3, the cartridge 100 may include a status indicator light 105, such as an LED, for each phase. When lit, the status indicator light 105 can be used to indicate that the surge protection system 50 remains in a ready, operational state in electrical contact with the load center and/or whether the cartridge 100 ought to be replaced. Optionally, in some embodiments, the status indicator light 105 is in line with the circuit breaker toggles (see, e.g., FIG. 20), so that when a consumer visually scans the load center 10 for a tripped breaker by scanning down each column of toggle switches, the surge protection status can easily be noted at the same time.

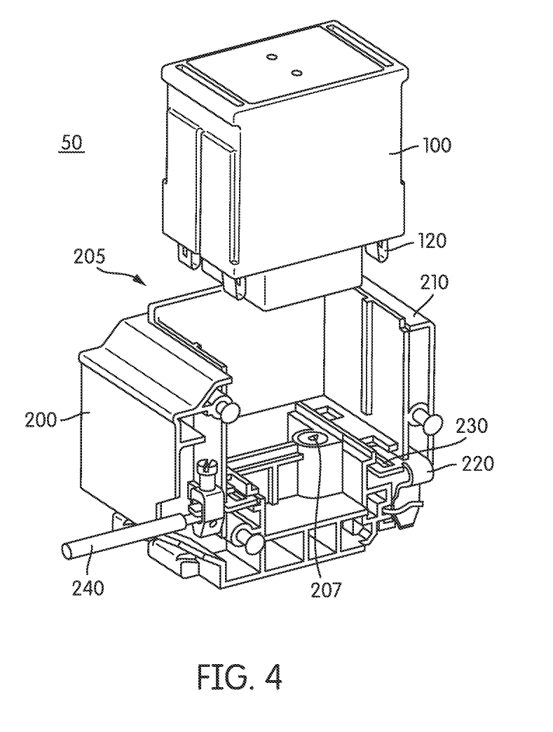

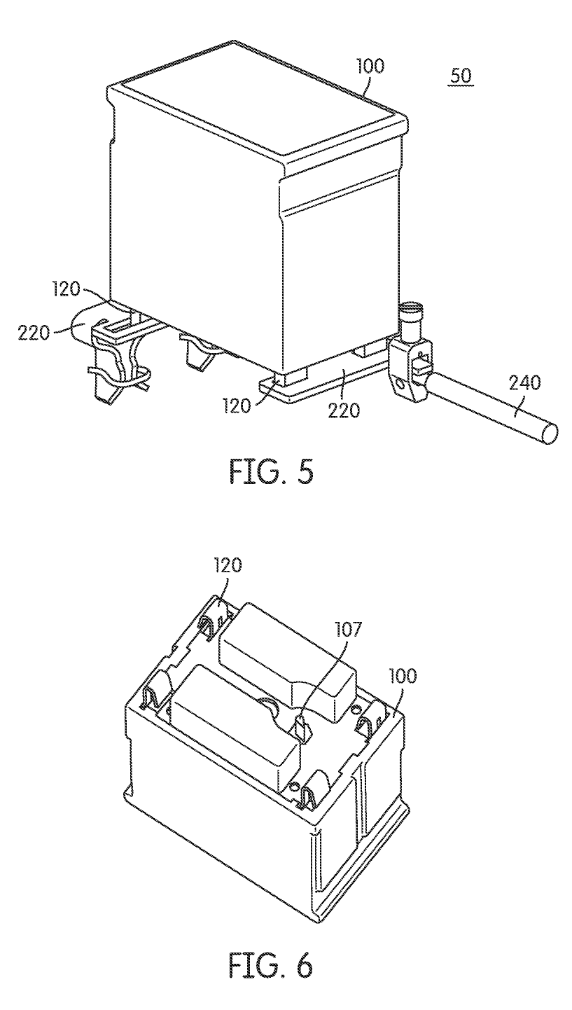

Turning to FIGS. 4 and 5, the base 200 includes a base housing 210, a plurality of base contacts 220, and a drain wire 240. The base housing 210 may be constructed of plastic or any other suitable insulating material. FIG. 4 illustrates the surge protection system 50 prior to cartridge insertion with a partial cross-sectional view of the base 200, while FIG. 5 illustrates the surge protection system 50 after cartridge insertion but with the base housing 210 removed. These views illustrate the arrangement of the base contacts 220 within the base 200, including a first array of base contacts designed to contact the power busbar and a second array of contacts that leads to neutral or ground, typically via the drain wire 240.

The base contacts 220 may be designed to employ a spring clip on the power side that engages a busbar stab (not shown) on the load center in a conventional manner as currently used with circuit breakers. The base contacts 220 on the neutral side can be connected to the drain wire 240; the drain wire 240 in turn can be attached to a second busbar (not shown) within the load center. Accordingly, when the cartridge 100 is inserted within the base 200, there is a closed circuit from the power busbar in the load center 10 through the surge protection system 50 to the second busbar.

The base contacts 220 may also be designed to engage cartridge contacts 120 protruding from the cartridge 100 that electrically and mechanically connect the cartridge 100 to the load center 10, as subsequently discussed in greater detail. In certain embodiments, as illustrated, this may include apertures 230 (FIG. 4) formed in the base contacts 220 to receive the cartridge contacts 120.

It will be appreciated that in some embodiments, the base may be provided as a stand-alone unit external to the electrical load center 10 and connected to it via phase and neutral wires without a direct connection of the base to the power busbar. It will further be appreciated that while exemplary embodiments are primarily used in load centers that operate on alternating current, surge protection systems 50 may also be employed in circumstances that employ direct current such as inverters, including those sometimes used with alternative energy sources such as solar and wind generation.

The base 200 may be sized to fit any pitch within a particular load center 10. Typically the base is a 0.75 inch pitch or a 1 inch pitch, which correspond to the two current standard pitch sizes for circuit breakers according to NEMA standards. The base 200 may be constructed to have the same size receptacle 205 for each pitch, such that the cartridge size is independent of the pitch used in a particular load center. As a result, a single replacement cartridge can be used in conjunction with multiple base sizes. This may help alleviate the possibility of consumer confusion, since a replacement cartridge would be suitable regardless of the pitch used by the load center or the consumer's understanding or knowledge of that fact.

FIGS. 4 and 6 illustrate that the cartridge 100 and base 200 may include one or more keying features to ensure proper insertion during initial installation and subsequent replacement of the cartridge. In one embodiment, a multi-position or dial type key 107 may be used to prevent improper cartridge and base combinations from inadvertently being made. For example, different key positions may be used to differentiate two phase from three phase, to differentiate different voltage ratings, to differentiate cartridges or bases associated with different manufacturers, or any other reason for establishing an association between a particular cartridge and a particular base. For example, if the key 107 is used to differentiate between two and three phrase configurations, should a user try to insert a two phase cartridge in a three phase base, the keying will not match. As a result, although the cartridge 100 may fit within the base receptacle 205, when the key 107 meets a key receptacle 207 formed in the base housing 210, the key 107 will not fit into the key receptacle 207 and will prevent mating.

Other keying features, such as complementary guide ribs and associated channels formed in the base 200 and cartridge 100 respectively (or vice versa), for example, may also be used. These keying features may be useful for embodiments in which it is desired to achieve a predetermined orientation of the cartridge 100 in the base 200 by providing ribs at a single end of the cartridge 100 to be received by corresponding channels at a single end of the base 200. This may be useful to prevent tilting, twisting, or leaning of an incorrect cartridge in an incorrect base that can prevent the base and cartridge contacts from touching, as well as to help prevent binding or jamming when a cartridge is inserted into an incorrect corresponding base.

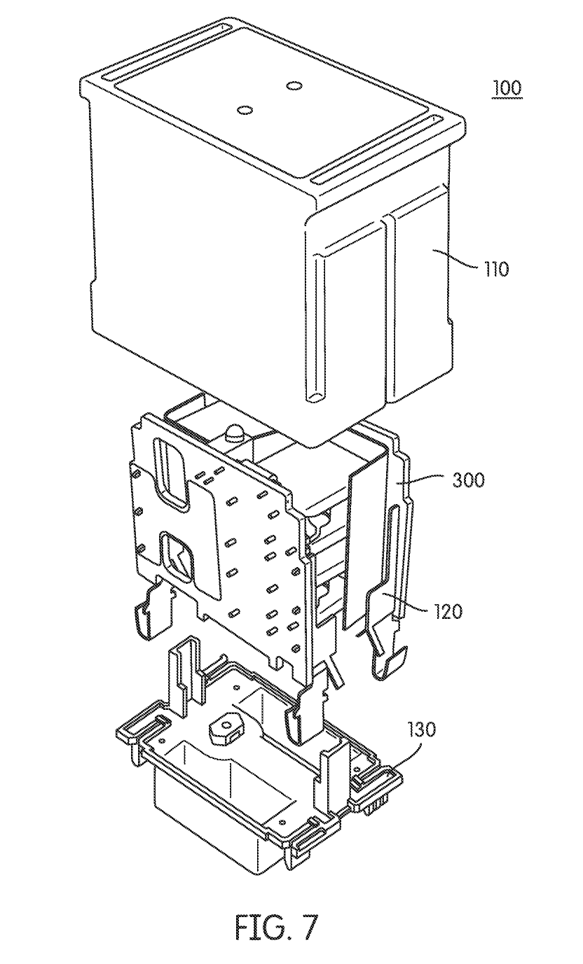

The cartridge 100 contains the electrical components that provide the surge protection functionality to the surge protection system 50. Turning to the exploded view of FIG. 7, the cartridge 100 includes a cartridge housing 110 and one or more surge protection assemblies 300 contained within the housing 110. Each surge protection assembly 300 provides an electrical path for surge protection of a single phase. The cartridge 100 may also include a base cap 130 to enclose the surge protection assemblies 300 within the cartridge housing 110. In embodiments employing multiple surge protection assemblies 300, the base cap 130 may be used to position the assemblies in a particular desired orientation prior to insertion within the housing 110.

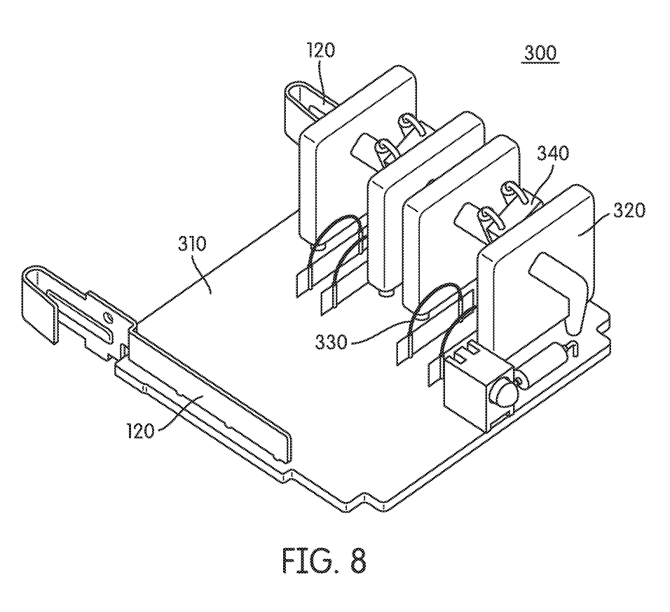

Turning to FIG. 8, a single surge protection assembly 300 is shown. The surge protection assembly 300 includes a printed circuit board (PCB) 310 and one or more surge protection elements 320 in electrical contact with the cartridge contacts 120 via the PCB 310. Advantageously, the cartridge contacts 120 may be soldered or otherwise attached directly to the PCB 310. The cartridge contacts 120 are elongated to extend outside the cartridge housing 110 to engage corresponding base contacts 220 within the base 200 to achieve mechanical and electrical connection as previously discussed.

Any type of surge protection element 320 may be used that adequately provides for a desired level of surge protection to be achieved and the type selected may depend on the particular surge rating a cartridge 100 is designed to achieve. In one embodiment, the surge protection element is a varistor, typically a metal oxide varistor (MOV), which are well known for use in surge protection applications. Other surge protection elements that may be used include gas discharge tubes, silicon avalanche diodes, and spark gaps, all by way of example. The surge protection assembly 300 may also include one or more fuse elements attached to the PCB 310, and in some embodiments, the surge protection assembly 300 includes a combination of wire fuses 330 and thermal fuses 340 as fuse elements. The various elements of the surge protection assembly 300 may be attached to the PCB 310 by soldering, for example, such as by wave soldering or by other suitable methods.

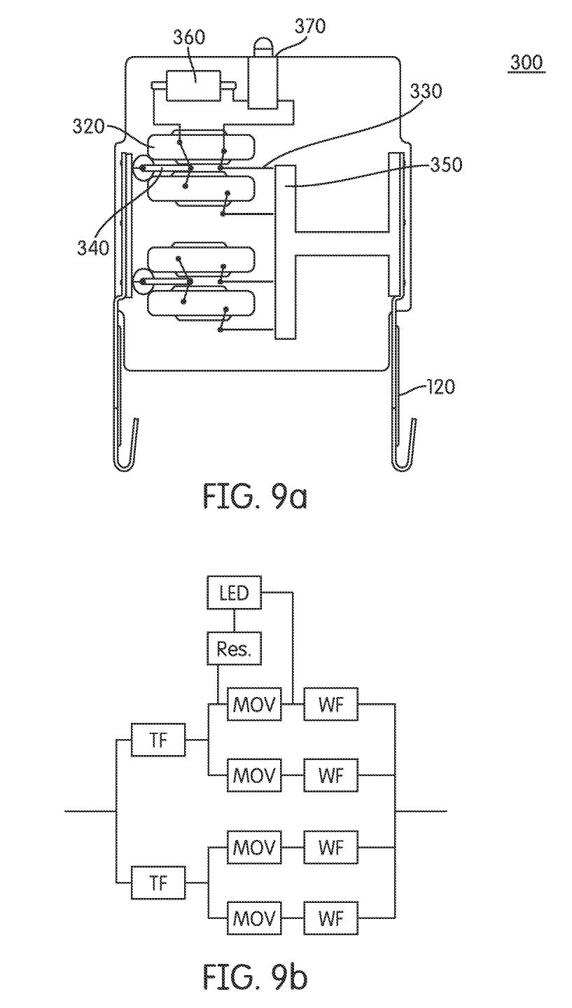

FIGS. 9a and 9b schematically and diagrammatically (respectively) illustrate the electrical path of a surge protection assembly 300 in accordance with one exemplary embodiment having four MOVs 320, four wire fuses 330 and two thermal fuses 340 in electrical contact with the PCB 310. It will be appreciated that the size of the tracings 350 on the PCB 310 in the schematic of FIG. 9a are exaggerated for purposes of illustration. In some embodiments, dual tracing may be used. That is, traces 350 may be provided on both sides of the PCB 310 to maximize surge current capacity of the surge protection assembly 300.

Still referring to FIGS. 9a and 9b, electrical current passes into the surge protection assembly from the load center 10 by way of a first one of the cartridge contacts 120 (via the base contacts 220 with which the cartridge contacts 120 are engaged when in operation). The current then flows in parallel through the two thermal fuses 340 (“TF” in FIG. 9b). The current through each thermal fuse 340 flows in parallel again through the MOV 320 and thin filament wire fuse 340 (“WF” in FIG. 9b) in series such that an electrical path is provided in which current can pass in parallel through any one of four paths of a thermal fuse, MOV and wire filament fuse in series. The current passes from the surge protection assembly 300 back to the load center 10 by the second cartridge contact 120 attached to the PCB 310.

FIGS. 9a and 9b further illustrate the manner in which a resistor 360 (“Res.” in FIG. 9b) and a status indicator light 105 (“LED” in FIG. 9b) can be connected within the surge protection assembly 300. It will be appreciated that the PCB and/or the arrangement of the elements attached thereto can be reversed without inhibiting the assembly's effectiveness (i.e. from right to left across the diagram shown in FIG. 9b instead of left to right).

The type, number and size of particular elements incorporated into the surge protection assembly 300 may depend on the system operating voltage and the overall surge protection rating desired to be achieved for the surge protection system 50. The exemplary embodiment illustrated in FIGS. 8 and 9a/9b includes four square MOVs with a 175V AC operating voltage and two thermal fuses rated at 110° C. The wire filaments are tin-coated copper wire. It will be appreciated that the ratings of the MOVs and thermal fuses, as well as the sizing of the wire filaments may vary to be appropriately sized for a particular application. In certain embodiments, the surge protection assembly may be capable of meeting the ANSI/UL1449 3^{rd} edition standard, including the embodiment illustrated in FIGS. 8 and 9a/9b. The use of internal fusing as described with respect to exemplary embodiments avoids the need to include additional upstream fusing while still providing a surge protection assembly that can repeatedly withstand a surge current of 10 kA. By avoiding the need to include upstream fusing, a potential failure mode is also removed.

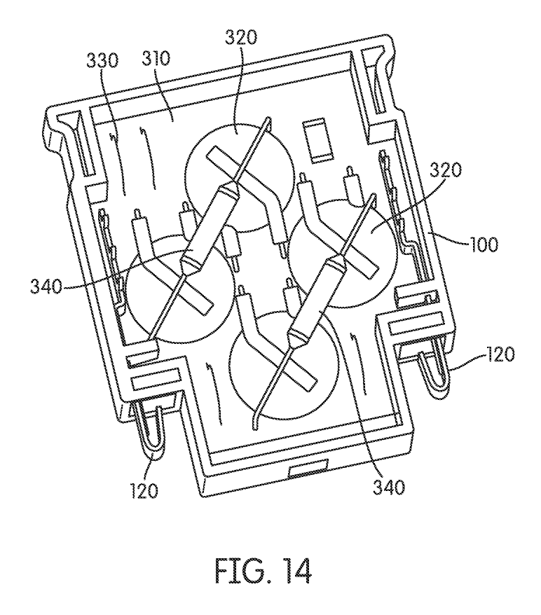

Although the components are shown in a particular topographical configuration in FIG. 8, it will be appreciated that the particular arrangement of the components on the PCB 310 to create the surge protection assembly 300 may be accomplished in any manner provided that the electrical path and the arrangement still achieves the desired result. FIG. 14 illustrates a single phase cartridge 100 having one alternative arrangement of the surge protection assembly 300 of FIG. 8 while using the same types of components (MOVs 320, wire filament fuses 330, and thermal fuses 340) having the same electrical path (i.e., as illustrated in FIG. 9b).

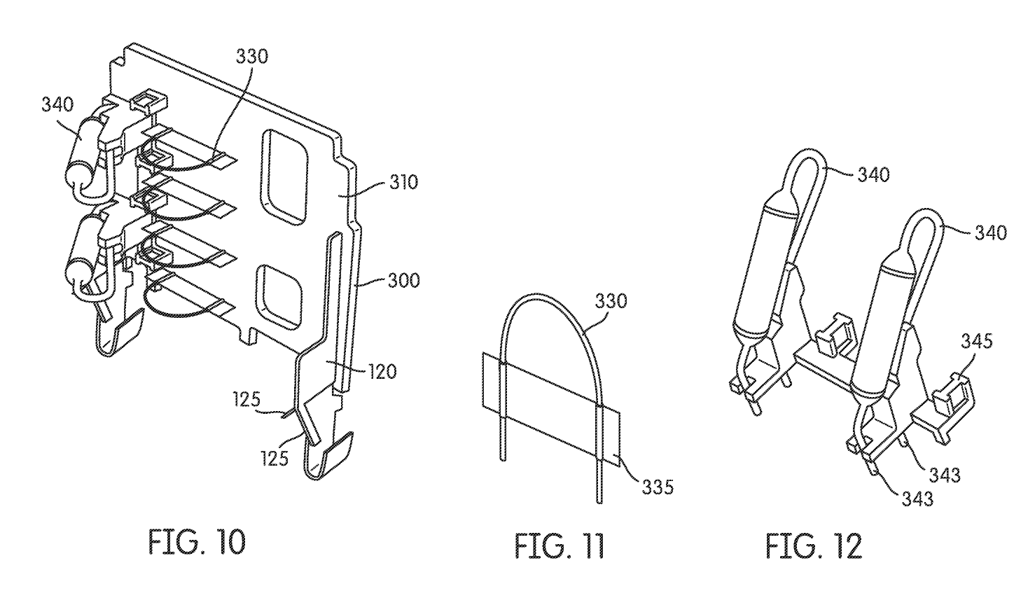

FIG. 10 illustrates the surge protection assembly 300 of FIG. 8 without MOVs for purposes of illustration and discussion of the fuse elements 330, 340 attached to the PCB board 310. As shown in FIGS. 10 and 11, the wire filament fuse 330 is a wire filament with two straight legs connected by a generally smooth arc such that angled bends are avoided.

It has been determined that the use of wire filament fuses 330 that do not have right angles or other sharp bends can better handle a surge current. Without wishing to be bound by theory, it is believed that wire filament fuses undergo strain hardening at tight bends and further that the magnetic moment of a surge current passing through such bends can cause premature failure of those fuses and diminished surge performance. The forces exerted on a wire filament fuse can be a function of both the magnitude of the surge current and the tightness of the bend.

In some embodiments a dielectric stop 335, such as a strip of polyimide tape (e.g. KAPTON tape), may be provided. The dielectric stop 335 can serve the dual purpose of defining and retaining the smooth curvature of the filament fuse 330, as well as establishing the depth to which the wire filament fuse 330 extends into the PCB 310 so that all of the wire filament fuses 330 are of an identical length.

As shown in FIGS. 10 and 12, the surge protection assembly 300 may include a thermal fuse carrier 345 to support the thermal fuses 340 and retain them in a predetermined position with respect to the PCB 310. The thermal fuse carrier 345 may be useful in achieving a consistent positioning and orientation of the thermal fuses 340 within the cartridge housing 110, which can in turn lead to more consistent product performance. The use of a thermal fuse carrier 345 may also aid in manufacturing by permitting the leads 343 of the thermal fuses 340 to be pre-positioned, limiting the adjustments that take place after the thermal fuses 340 have been placed on the PCB 310.

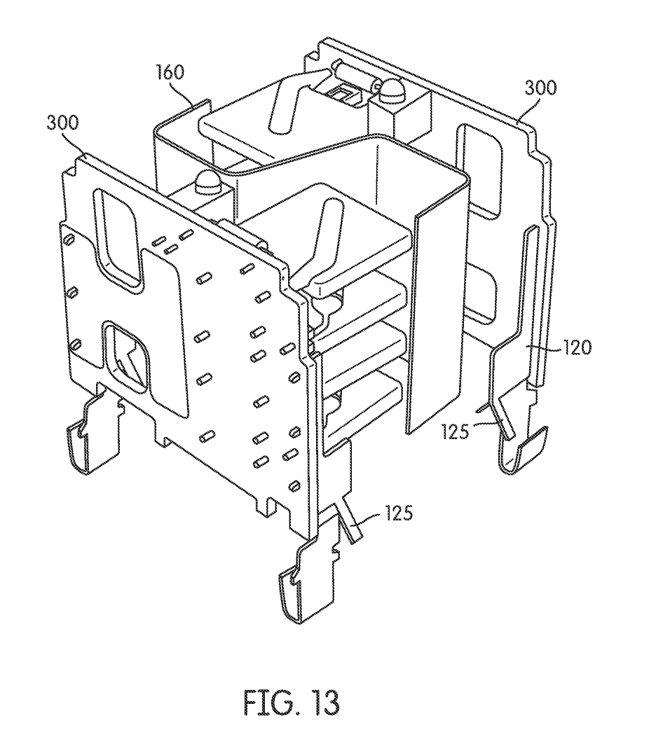

As previously discussed, cartridges 100 in accordance with exemplary embodiments may contain multiple surge protection assemblies 300. The elements of the surge protection assembly 300 may be arranged so that two assemblies 300 can be nested, as seen in FIG. 7 and better seen in FIG. 13. Nesting can minimize space requirements and better enable a two phase system to fit within a base for a ¾ in. pitch and/or 1 in. pitch. In embodiments in which two or more surge protection assemblies 300 are present within the cartridge 100, a dielectric sheet 160, such as mica paper, may be used to provide for more complete electrical isolation and reduce the likelihood of arcing between the two assemblies 300 during a surge event.

FIG. 13 also illustrates that in certain embodiments, the cartridge contacts 120 are j-style contacts that have a j-hook at one end, being designed to be seated within slots formed in the plate-style base contacts of the base. The use of j-style cartridge contacts 120 can achieve a firm and reliable connection between the cartridge 100 and the base 200 to withstand ejection during a surge event while still being readily removable by the consumer after the cartridge 100 is spent and in need of replacement. The cartridge contacts 120 may also include lances 125, which can be formed during the contact manufacturing process, such as by stamping. The lances 125 act as a mechanical catch that can prevent the cartridge contacts 120 from traveling within the cartridge 100 in response to an applied insertion or extraction force.

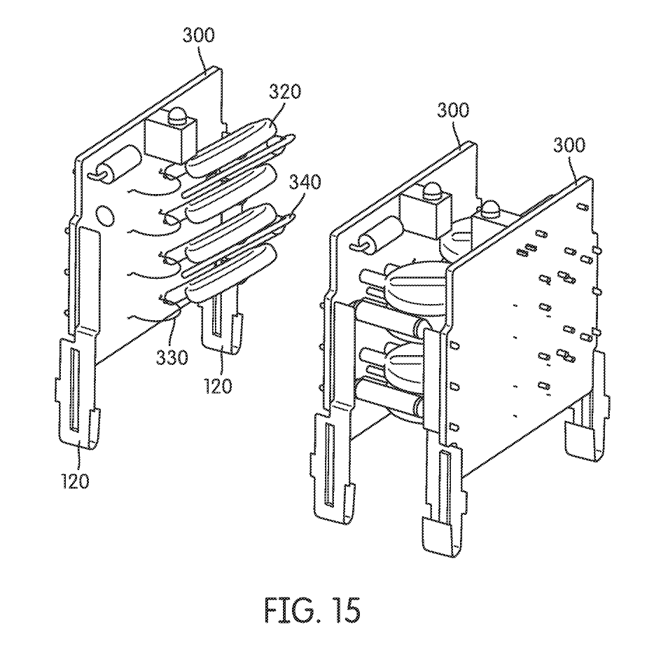

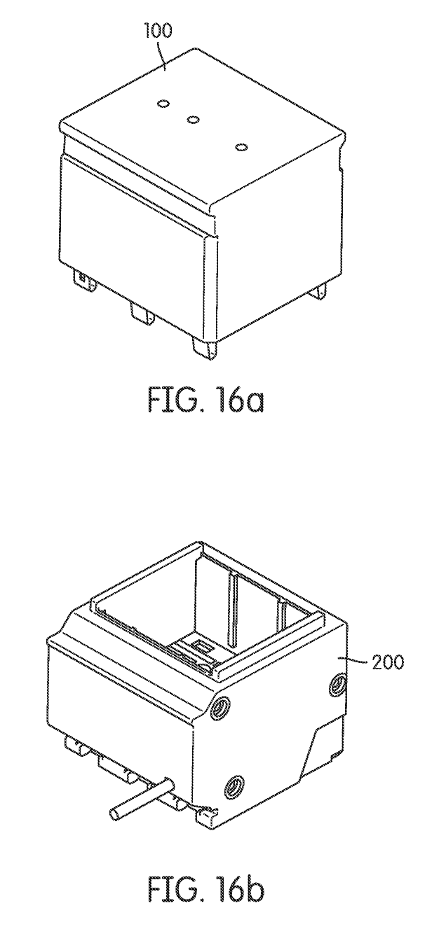

Turning to FIGS. 15, 16a and 16b, a three-phase embodiment is shown in which a third surge protection assembly 300 (FIG. 15) is provided in combination with two nested surge protection assemblies 300 similar to that which was described with respect to FIG. 13. The three assemblies 300 are contained within a three-phase cartridge 100 (FIG. 16a) which is receivable within a three-phase base 200 (FIG. 16b), but which otherwise operates in essentially the same manner described elsewhere herein with respect to a two-phase cartridge and base surge protection system 50. FIG. 15 also illustrates the manner in which the MOVs 320 and/or other elements attached to the PCB 310 can be angled to provide for denser packing of the assembly 300 within the cartridge 100.

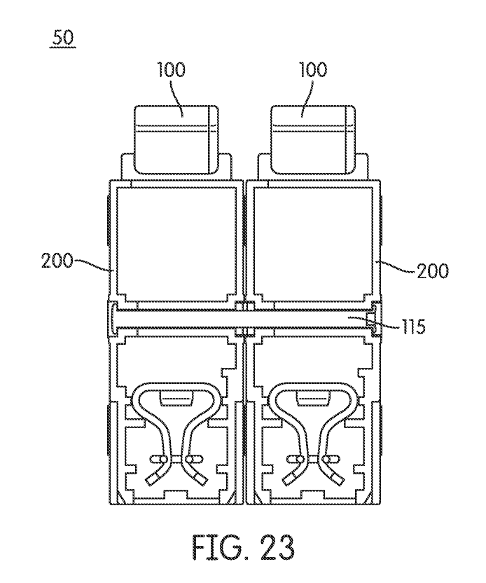

It will be appreciated that two and three phase surge protection systems 50 can also be constructed by ganging together multiple single phase bases. For example, a two phase surge protection system may be provided by two single phase cartridges 100 each inserted into two ganged single phase bases 200. The bases 200 can be joined, again by way of example, by a rivet 115 extending between them as shown in the exemplary embodiment illustrated in FIG. 23.

Regardless of whether the cartridge 100 contains one or multiple surge protection assemblies 300, extra space remaining within the volume of the cartridge housing 110 after placement of the surge protection assembly (or assemblies) may be filled with a dielectric filler to displace air such as, for example, electrical grade silica. This reduces the volume of oxygen contained within the cartridge and reduces the likelihood of combustion during a significant overvoltage condition. The silica also acts to smother arcs and flame events as they occur, adds thermal mass to the cartridge 100, and acts as a heat sink during thermal events. An epoxy potting material or other dielectric filler may also be used alone or in combination with the silica to fill and/or seal the cartridge housing. The potting material may, for example, be used to secure the base cap 130 to the housing 110.

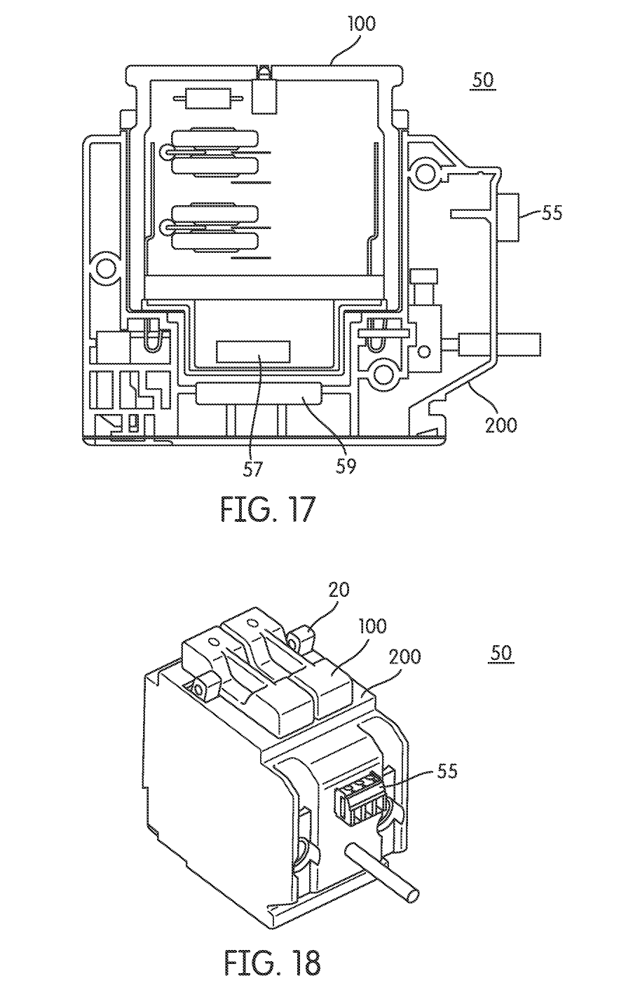

In some embodiments, as seen in FIGS. 17 and 18, the surge protection system 50 may include a remote monitoring device 55 in addition to, or in lieu of, a visual indicator to monitor system performance. The remote monitoring device 55 can send signals about the operation of the surge protection system 50 to a location remote from the load center, where that information may be used for analysis and/or for a subsequent undertaking, such as generating an alert. The signal from the remote monitoring device 55 may be sent over a land line, such as a telephone or Ethernet line, or may be a WiFi, Bluetooth or other wireless signal. To prevent the remote monitoring device 55 from becoming disabled as a result of a surge event, that device may include a circuit electrically isolated from the circuit being protected by the surge protection system 50. In one embodiment, as illustrated in FIG. 17, electrical isolation can be achieved by an electromagnet 57 connected to the PCB 310 within the cartridge 100 in which the electromagnet 57 is in communication with a reed switch 59 in the base 200. When the cartridge 100 fails and needs to be replaced, the open circuit in the cartridge causes the electromagnet 57 to stop working, which causes the reed switch to close and thereby activating the remote monitoring device 55.

In addition to the remote monitoring device 55, FIG. 18 also illustrates that some embodiments may include additional functional features incorporated in the pluggable surge protection system 50, such as integrating circuit breakers 20 into the base 200. As a result, some exemplary embodiments can be used to provide overcurrent and overvoltage protection in a single system.

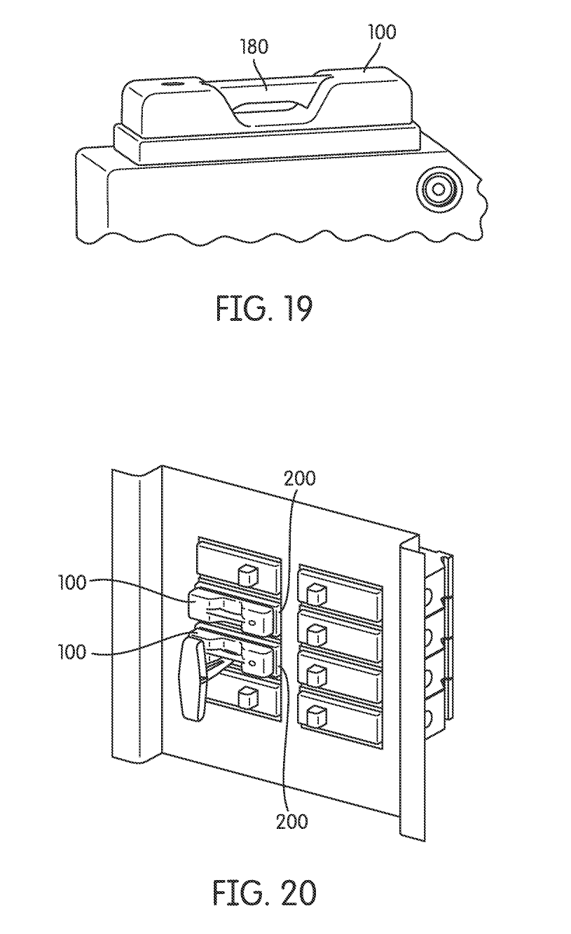

As shown in FIG. 1 and elsewhere, the cartridge housing 110 may include a ridge or other features on its upper, outer surface for a user to grasp when handling the cartridge 100 for insertion or removal. Alternatively or additionally, as shown in FIGS. 19 and 20, the cartridge 100 may be provided with a handle 180 such as a tab to facilitate extraction from the base 200 by the use of the fingers, or with a pair of pliers or other similar tool. As illustrated, the handle 180 may be slotted, for example, to provide an integrated tool attachment feature for use with an extraction tool to pull the cartridge from the base (FIG. 20).

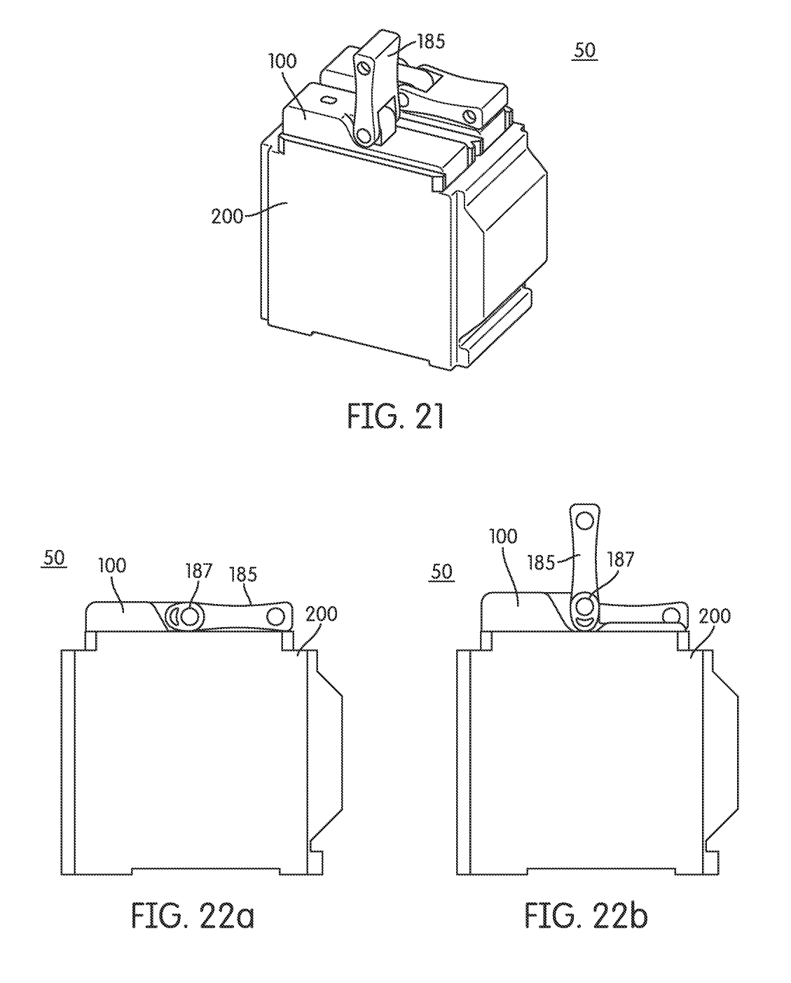

According to yet another embodiment, shown in FIG. 21, the cartridge 100 may be provided with a flip-up handle 185 that pivots between an extended position (shown with respect to the cartridge in the foreground) and a refracted position (shown with respect to the cartridge in the background). Electrical load centers generally include an access door; that door can act as a limit on the height of the cartridge from the dead panel. A flip-up handle 185 may be desirable to provide additional surface area to grasp the cartridge 100 during installation and/or extraction from the base for replacement. Once the cartridge 100 has been inserted into the base 200, the handle 185 can flip down to its retracted position to avoid interference with the door of the load center.

FIGS. 22a and 22b illustrate a variation of the flip-up handle 185 in which a cam 187 is attached to, and actuated by, the handle 185. The cam 187 presses on the base 200 as the handle 185 pivots to the extended position. This results in a slight movement of the cartridge 100 away from the base 200 which is sufficient to partially or fully disengage the cartridge contacts from the base contacts. This lessens the resistance force during pulling, further easing extraction of the cartridge 100 from the base 200. Alternatively, a latch may be provided so that when the cartridge 100 is inserted into the base 200, the handle 185 activates a latch that closes to retain the cartridge 100 in position as the handle 185 is rotated to its lowered (i.e., flat) position. When the handle 185 is rotated back to its operative (i.e., extended) position, the latch is released and the cartridge 100 can be withdrawn.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A pluggable surge protection cartridge comprising:
a housing;
a surge protection assembly situated within the housing containing a surge protection element; and
a plurality of cartridge contacts in electrical contact with the surge protection assembly, the cartridge contacts configured to engage a base within an electrical load center and carry a surge current from the load center across an electrical path of the surge protection assembly through the surge protection element,
wherein the cartridge is configured to be situated within the base such that the cartridge is removable from the base while the base remains in electrical contact with the load center.

2. The cartridge of claim 1, wherein the surge protection assembly comprises a printed circuit board; a metal oxide varistor as the surge protection element; and a fuse element, the metal oxide varistor and fuse element attached and in electrical contact with the printed circuit board to define the electrical path across the surge protection assembly.

3. The cartridge of claim 2, wherein the surge protection assembly comprises a thermal fuse and a wire filament fuse as fuse elements.

4. The cartridge of claim 2, wherein the surge protection assembly comprises a thermal fuse carrier mounted on the printed circuit board, the thermal fuse carrier supporting a thermal fuse in electrical contact with the printed circuit board such that the thermal fuse is retained in a predetermined position with respect to the printed circuit board.

5. The cartridge of claim 2, wherein the surge protection assembly comprises a wire filament fuse, wherein the wire filament fuse comprises a wire filament configured to consist of two straight leg portions connected by a smooth arc portion.

6. The cartridge of claim 5, wherein the wire filament is retained in its configuration by a dielectric tape.

7. The cartridge of claim 2, wherein the surge protection assembly comprises a thermal fuse carrier mounted on the printed circuit board, the thermal fuse carrier supporting a thermal fuse in electrical contact with the printed circuit board such that the thermal fuse is retained in a predetermined position with respect to the printed circuit board and wherein the surge protection assembly comprises a wire filament fuse, wherein the wire filament fuse comprises a wire filament configured to consist of two straight leg portions connected by a smooth arc portion.

8. The cartridge of claim 1, wherein the surge protection assembly comprises four metal oxide varistors as the surge protection element, four wire filament fuses, and two thermal fuses attached to a printed circuit board, wherein the electrical path comprises multiple parallel paths of a thermal fuse, metal oxide varistor and wire filament fuse in series.

9. The cartridge of claim 1, wherein a base cap retains the surge protection assembly within the housing.

10. The cartridge of claim 1, wherein the cartridge further comprises a dielectric filler within the housing.

11. The cartridge of claim 1, wherein the cartridge comprises a plurality of surge protection assemblies.

12. The cartridge of claim 11, further comprising a dielectric sheet disposed intermediate the plurality of surge protection assemblies.

13. The cartridge of claim 1, wherein the cartridge contacts have a j-hook at one end to engage contacts in a base member corresponding to the cartridge.

14. The cartridge of claim 1, wherein the cartridge contacts comprise at least one lance situate within the housing, the lance configured to resist movement of the cartridge contacts with respect to the housing.

15. The cartridge of claim 1, wherein the cartridge further includes an LED in electronic contact with the surge protection assembly such that the LED is lit when the surge protection assembly is operational and in electrical contact with the load center.

16. The cartridge of claim 1, wherein the cartridge is a two-phase cartridge comprising two surge protection assemblies.

17. The cartridge of claim 1, wherein the cartridge comprises a handle.

18. The cartridge of claim 17, wherein the handle pivots between an extended position and a retracted position.

19. The cartridge of claim 18, further comprising a cam attached to the handle, wherein the cam is actuated by pivoting the handle from the retracted position to the extended position.

20. A pluggable surge protection cartridge comprising:
a housing;
a surge protection assembly situated within the housing comprising a printed circuit board, a plurality of metal oxide varistors, a plurality of thermal fuses, and a plurality of wire filament fuses, wherein the varistors, thermal fuses and wire filament fuses are in electrical contact with the printed circuit board to form an electrical path in which current travels in multiple parallel paths across each of a thermal fuse, varistor and wire filament fuse in series, wherein the thermal fuses are supported by a thermal fuse carrier mounted on the printed circuit board such that the thermal fuses are retained in a predetermined position with respect to the printed circuit board and wherein the wire filament fuses each comprise a wire filament configured to consist of two straight leg portions connected by a smooth arc portion;
a plurality of cartridge contacts in electrical contact with the surge protection assembly, the cartridge contacts having a j-hook at one end to engage a corresponding base within an electrical load center and carry a surge current from the load center across the electrical path of the surge protection assembly, the cartridge contacts further comprising a lance situate within the housing, the lance configured to resist movement of the cartridge contacts with respect to the housing; and
a dielectric filler within the housing,
wherein the cartridge is configured to be situated within the base such that the cartridge is removable from the base while the base remains in electrical contact with the load center.

21. A surge protection system comprising:
a base configured to attach to a busbar of an electrical load center and be in electrical contact therewith, the base having a receptacle formed therein; and
a cartridge containing a surge protection assembly having a surge protection element, the cartridge configured to be received in the base receptacle such that the cartridge is in mechanical and electrical contact with the base, the cartridge further being in electrical contact with the load center via the base such that a surge current passing through the load center flows through the surge protection element contained within the cartridge,
wherein the cartridge is removable from the base while the base remains in electrical contact with the load center.

22. The surge protection system of claim 21 further comprising a remote monitoring device.

23. The surge protection system of claim 22, wherein the remote monitoring device is controlled by a circuit that includes a reed switch and an electromagnet.

24. The surge protection system of claim 21, wherein the base and cartridge have corresponding keying mechanisms such that the base and cartridge are in mechanical and electrical contact when the corresponding keying mechanisms are aligned.

25. A pluggable surge protection base comprising:
a base housing having a receptacle formed therein for receiving a surge protection cartridge and adapted to fit within an expansion slot of a load center;
a first array of one or more base contacts within the base housing adapted to attach to one or more busbars of an electrical load center and to engage a first cartridge contact of the surge protection cartridge; and
a second array of one or more base contacts within the base housing adapted to engage a second cartridge contacts of the surge protection cartridge, the second array of base contacts in electrical contact with the load center via a drain wire.

26. The base of claim 25, wherein the base housing is adapted to fit within a 0.75 inch pitch or a 1.0 inch pitch expansion slot of the load center.

27. The base of claim 26, wherein the base receptacle size does not change with pitch size.

28. The base of claim 25, wherein the base is selected from the group consisting of a single-phase base, a two-phase base, and a three-phase base.

29. The base of claim 25, wherein the base further comprises a circuit breaker.

30. A method of manufacturing a surge protection assembly comprising constructing a surge protection circuit, the circuit containing at least one wire filament fuse, wherein the wire filament fuse is arranged in a predetermined geometry that is maintained through the use of an insulating material, the insulating material also defining a predetermined depth to which the wire filament fuse extends into a circuit board of the surge protection assembly.
